(19) United States
(12) Patent Application Publication
(10) Pub. No.: US 2026/0266648 A1
(43) Pub. Date: Sep. 10, 2026

(54) LOAD TRANSFER ASSEMBLY

(71) Applicant: Illinois Tool Works Inc., Glenview, IL (US)

(72) Inventor: Andrew Gary FOX, Birmingham (GB)

(21) Appl. No.: 19/559,659

(22) Filed: Mar. 6, 2026

(30) Foreign Application Priority Data
Mar. 10, 2025 (GB) 2503444.8

(51) Int. Cl. G01G 19/02

(52) U.S. Cl. CPC G01G 19/024

(57) ABSTRACT

This disclosure relates to a weighbridge having a deck, a load cell and a load transfer assembly. The load transfer assembly is configured to transfer displacement of the deck to the load cell, in use, and includes a base for attachment to a static substrate. The base has a first seat for receipt of an end of the load cell and a load cell seating element attached to the deck and configured to move therewith. The load cell seating element has a second seat for receipt of another end of the load cell and one or more mounting slots for attaching the load cell seating element to the deck. The mounting slots are configured to allow for positional adjustment of the second seat relative to the deck.

### FIELD OF THE DISCLOSURE

This disclosure relates generally to a load transfer assembly for a weighbridge, and more specifically to a load transfer assembly for a weighbridge that utilises a load cell. This disclosure also relates to a weighbridge incorporating a load transfer assembly and a kit of parts. The disclosure further relates to a method of installing a load transfer assembly within a weighbridge.

Weighbridges, otherwise known as truck scales or railroad scales, are scales used to weigh rail or road vehicles and their contents. This can help ensure vehicles comply with the law whilst transporting goods and/or can allow companies to determine the weight of the contents of vehicles to ensure that customers are charged correctly. Weighbridges are often permanent installations, mounted on a concrete foundation and may be recessed relative to the surrounding substrate (a so called “pit-mounted” weighbridge) or may be positioned above the surrounding substrate (a so called “above-ground” weighbridge).

When a new weighbridge is to be installed at a site, it is often the case that the site is already provided with a concrete slab or pit and/or one or more ramps. This may be due to preparatory groundworks having already taken place, or the new weighbridge is being installed to replace a pre-existing one. However, because of this it has been found that when installing a new weighbridge, the load points of the existing concrete slab or pit may not match-up with the load points on the new weighbridge. As a result, extensive additional groundworks or deck modifications may be required at the site to facilitate the installation of the new weighbridge, increasing the overall time and cost of installation.

It is therefore a first non-exclusive object of the disclosure to provide a weighbridge having a load cell that overcomes one or more disadvantages of known weighbridges.

### SUMMARY

Accordingly, an aspect of the disclosure provides a weighbridge comprising: a deck; a load cell; and a load transfer assembly configured to transfer displacement of the deck to the load cell, in use.

The load transfer assembly may comprise: a base for attachment to a static substrate, the base comprising a first seat for receipt of an end of the load cell.

The load transfer assembly may comprise a load cell seating element attached to the deck, e.g. an underside thereof, and configured to move therewith, wherein the load cell seating element comprises a second seat for receipt of another end of the load cell.

The load cell seating element may comprise one or more mounting slots for attaching the load cell seating element to the deck, wherein the mounting slots are configured to allow for positional adjustment of the second seat relative to the deck.

The load transfer assembly may comprise an adjustment means to facilitate adjustment of the first seat relative to the base and/or the second seat. The adjustment means may be configured to facilitate adjustment of the first seat towards and/or away from the base. The adjustment means may be configured to facilitate adjustment of the first seat towards and/or away from the deck, e.g. an underside thereof.

The adjustment means may comprise a spacing element positioned between the base and the first seat.

The first seat may be configured to engage the spacing element. The spacing element may engage the base. The spacing element may be annular. The spacing element may be or may comprise a disc.

The spacing element may comprise an aperture and the first seat, e.g. an underside thereof, may comprise a projection. The projection may engage the aperture.

The weighbridge or spacing element may comprise a plurality of stacked or stackable spacing elements.

The load transfer assembly may comprise a load cell alignment compensator positioned between the first seat and the base.

The load transfer assembly may comprise a load cell alignment compensator positioned between the second seat and the deck, e.g. an underside thereof.

The load cell alignment compensator may comprise a convex protrusion, e.g. configured to facilitate adjustment of the angle of the first seat relative to the base, in use.

The load cell alignment compensator may comprise a concave recess, e.g. configured to facilitate adjustment of the angle of the first seat relative to the base, in use.

Another aspect of the disclosure provides a weighbridge comprising: a deck; a load cell; and a load transfer assembly configured to transfer displacement of the deck to the load cell, in use; wherein the load transfer assembly comprises: a base for attachment to a static substrate, the base comprising a first seat for receipt of an end of the load cell; a load cell seating element attached to the deck and configured to move therewith, wherein the load cell seating element comprises: a second seat for receipt of another end of the load cell; and one or more mounting slots for attaching the load cell seating element to the deck, wherein the mounting slots are configured to allow for positional adjustment of the second seat relative to the deck.

Advantageously, the load transfer assembly enables a new weighbridge to be installed at an existing site, whereby the load points of the existing concrete slab or pit may not match-up with the load points on the new weighbridge. The load transfer assembly facilitates adjustment of the position of a load loading point, and load cell itself, relative to the deck of the weighbridge, enabling more efficient manufacture and installation of a new weighbridge.

The mounting slots comprise a plurality of slots.

The load cell seating element may be attached to the deck via a bracket. The bracket may comprise a U-channel section. The load cell seating element may be attached to the base of the U-channel section. The bracket may be constrained to move with the deck.

The mounting slots may comprise pair of laterally extending slots. The laterally extending slots may be configured to allow for lateral adjustment of the second seat relative to the deck and/or bracket.

The expression “lateral” may be understood to mean extending transverse or orthogonal to a principal or longitudinal axis of the weighbridge.

The mounting slots may comprise a pair of longitudinally extending slots. The longitudinally extending slots may be configured to allow for longitudinal adjustment of the second seat relative to the deck.

The expression “longitudinal” may be understood to mean extending parallel to or along a principal or longitudinal axis of the weighbridge.

The mounting slots may be elongate. Each of the mounting slots may be identical, e.g. in one or more of shape, orientation and size.

The load cell seating element may comprise a first plate mounted to the deck or bracket. The load cell seating element may comprise a second plate mounted to the first plate.

The second plate may comprises an aperture. The second seat may be defined by the aperture and the first plate. The base of the second seat may be provided or defined by the first plate.

The first plate may comprise a first pair of mounting slots. The second plate may comprise a second pair of mounting slots. The first pair of mounting slots may extend transverse or orthogonal to the second pair of mounting slots.

The mounting slots of the first pair of mounting slots may be parallel to one another and/or the mounting slots of the second pair of mounting slots may be parallel to one another.

The first pair of mounting slots may extend laterally with respect to the deck. The first pair of mounting slots may extend longitudinally with respect to the deck

Each of the mounting slots of the first pair of mounting slots may be aligned with a respective aperture in the deck or bracket. Each of the mounting slots of the second pair of mounting slots may be aligned with a respective aperture in the first plate.

The first plate may be located between the deck and the second plate. The second plate may be attached to the deck via the first plate.

The load cell seating element may be attached to an underside of the deck. The load cell seating element may be attached within an end box of the deck.

The load transfer assembly may comprise a load cell supporting element mounted to or in engagement with the base. The load cell supporting element may be or may comprise the first seat. The load cell supporting element may support the first seat.

The load cell supporting element may comprise an adjustment means to facilitate adjustment of the first seat relative to the base.

The load transfer assembly may comprise an adjustment means to facilitate adjustment of the first seat relative to the base. The adjustment means may be configured to facilitate adjustment of the first seat towards and/or away from the base. The adjustment means may be configured to facilitate adjustment of the first seat towards and/or away from the deck, e.g. an underside thereof.

The adjustment means may comprise a spacing element positioned between the base and the first seat.

The first seat may be configured to engage the spacing element. The spacing element may engage the base. The spacing element may be annular. The spacing element may be or may comprise a disc.

The spacing element may comprise an aperture and the first seat may comprise a projection. The projection may engage the aperture.

The weighbridge or spacing element may comprise a plurality of stacked or stackable spacing elements.

The or each spacing element(s) may be removable.

The load cell supporting element or base may comprise a spacing element seat, e.g. for receipt of the spacing element(s).

Advantageously, the spacing element(s) enable a new weighbridge to be installed at an existing site, whereby the vertical distance between the load points of the existing concrete slab and the load points on the new weighbridge is greater than the length of the load cell. The spacing element(s) accommodate the load cell at an existing site.

The load transfer assembly may comprise a load cell alignment compensator positioned between the first seat and the base.

The load transfer assembly may comprise a load cell alignment compensator positioned between the second seat and the deck, e.g. an underside thereof.

The load cell alignment compensator may comprise a convex protrusion, e.g. configured to facilitate adjustment of the angle of the first seat relative to the base, in use.

The load cell alignment compensator may comprise a concave recess, e.g. configured to facilitate adjustment of the angle of the first seat relative to the base, in use.

The load cell alignment compensator may support the first seat.

The convex protrusion may extend from the base. The convex protrusion may be attached to the base.

The concave recess may be formed in the base. The concave recess may be formed in an attachment to the base.

The load cell supporting element may comprise a concave portion configured to engage the convex protrusion. The load cell supporting element may comprise a convex portion configured to engage the concave recess. The load cell supporting element may be movable relative to the convex protrusion or concave recess to facilitate adjustment of the angle of the first seat relative to the base, in use.

The load cell supporting element may be located between the convex protrusion or concave recess and the spacing element(s).

The load cell supporting element may comprise the convex or concave portion on a first side and the spacing element seat on a second side.

The load cell supporting element may comprise a disc or plate.

The first seat may comprise a concave portion configured to engage the convex protrusion. The first seat may comprise a convex portion configured to engage the concave recess. The first seat may be movable relative to the convex protrusion or concave recess to facilitate adjustment of the angle of the first seat relative to the base, in use.

The adjustment means or spacing element may comprise a concave portion configured to engage the convex protrusion. The adjustment means or spacing element may comprise a convex portion configured to engage the concave recess. The adjustment means or spacing element may be movable relative to the convex protrusion or concave recess to facilitate adjustment of the angle of the first seat relative to the base, in use.

The load cell supporting element may otherwise be referred to as a base plate.

The spacing element(s) may be positioned between the load cell supporting element or base plate and the first seat.

The load transfer assembly may be received within an end box of the weighbridge.

The load cell may comprise a compression load cell.

Another aspect of the disclosure provides a weighbridge comprising: a deck; a load cell; and a load transfer assembly configured to transfer displacement of the deck to the load cell, in use; wherein the load transfer assembly comprises: a base for attachment to a static substrate, the base comprising a first seat for receipt of an end of the load cell; a load cell seating element attached to the deck and configured to move therewith, wherein the load cell seating element comprises a second seat for receipt of another end of the load cell: wherein: the load cell seating element comprises one or more mounting slots for attaching the load cell seating element to the deck, and/or the base comprises one or more mounting slots for attaching the first seat to the base; wherein the mounting slots are configured to allow for positional adjustment of the first seat and/or second seat relative to the deck.

The mounting slots may comprise pair of laterally extending slots. The laterally extending slots may be configured to allow for lateral adjustment of the first seat relative to the deck and/or base.

The mounting slots may comprise a pair of longitudinally extending slots. The longitudinally extending slots may be configured to allow for longitudinal adjustment of the first seat relative to the deck and/or base.

The load cell seating element may comprise a first plate mounted to the base. The load cell seating element may comprise a second plate mounted to the first plate.

The second plate may comprise an aperture. The first seat may be defined by the aperture and the first plate. The base of the first seat may be provided or defined by the first plate.

The first plate may be located between the base and the second plate. The second plate may be attached to the base via the first plate.

The load cell seating element may be attached, e.g. to the base, within an end box of the deck.

Another aspect of the disclosure provides a weighbridge comprising: a deck; a load cell; and a load transfer assembly configured to transfer displacement of the deck to the load cell, in use; wherein the load transfer assembly comprises: a base for attachment to a static substrate, the base comprising a first seat for receipt of an end of the load cell; the load transfer assembly further comprising an adjustment means to facilitate adjustment of the first seat relative to the base, wherein the adjustment means comprises a spacing element positioned between the base and the first seat.

The weighbridge or spacing element may comprise a plurality of stacked or stackable spacing elements.

The adjustment means may be configured to facilitate adjustment of the first seat towards and/or away from the base. The adjustment means may be configured to facilitate adjustment of the first seat towards and/or away from the deck, e.g. an underside thereof.

Another aspect of the disclosure provides a weighbridge comprising: a deck; a load cell; and a load transfer assembly configured to transfer displacement of the deck to the load cell, in use; wherein the load transfer assembly comprises: a base for attachment to a static substrate, the base comprising a first seat for receipt of an end of the load cell; the load transfer assembly further comprising a load cell alignment compensator positioned between the first seat and the base, wherein the load cell alignment compensator comprises a convex protrusion configured to facilitate adjustment of the angle of the first seat relative to the base, in use.

Another aspect of the disclosure provides a load transfer assembly for a weighbridge, the assembly comprising: a base for attachment to a static substrate, the base comprising a first seat for receipt of an end of the load cell; a load cell seating element arranged to be attached to a deck of a weighbridge, and configured to move therewith, in use, wherein the load cell seating element comprises: a second seat for receipt of another end of the load cell; and one or more mounting slots for attaching the load cell seating element to a deck of a weighbridge, wherein the mounting slots are configured to allow for positional adjustment of the second seat relative to the deck, in use.

The load transfer assembly may comprise a load cell supporting element mounted to the base. The load cell supporting element may comprise the first seat. The load cell supporting element may comprise an adjustment means to facilitate adjustment of the first seat relative to the base.

The adjustment means may comprise a removable spacing element positioned between the base and the first seat.

Another aspect of the disclosure provides a load transfer assembly for a weighbridge, the assembly comprising: a base for attachment to a static substrate, the base comprising a first seat for receipt of an end of the load cell; the load transfer assembly further comprising an adjustment means to facilitate adjustment of the first seat relative to the base, wherein the adjustment means comprises a spacing element positioned between the base and the first seat.

Another aspect of the disclosure provides a load transfer assembly for a weighbridge, the assembly comprising: a base for attachment to a static substrate, the base comprising a first seat for receipt of an end of the load cell; the load transfer assembly further comprising a load cell alignment compensator positioned between the first seat and the base, wherein the load cell alignment compensator comprises a convex protrusion configured to facilitate adjustment of the angle of the first seat relative to the base, in use.

Another aspect of the disclosure provides a kit of parts comprising a base for attachment to a static substrate and a first seat for receipt of an end of a load cell.

The kit of parts may comprise one or more of a load cell, a weighbridge and one or more fixings configured to attach or secure the base to a static substrate.

The kit of parts may comprise a load cell seating element arranged to be attached to a deck of a weighbridge, in use, as described above.

The kit of parts may comprise an adjustment means to facilitate adjustment of the first seat relative to the base, in use, as described above.

The kit of parts may comprise a load cell alignment compensator configured to facilitate adjustment of the angle of the first seat relative to the base, in use, as described above.

Another aspect of the disclosure provides a method of installing a load transfer assembly within a weighbridge, the method comprising: providing a load cell seating element comprising: a first seat for receipt of an end of a load cell; and one or more mounting slots for attaching the load cell seating element to the deck; wherein the mounting slots are configured to allow for positional adjustment of the first seat relative to the deck; aligning the one or more slots with a respective aperture in a deck of a weighbridge and attaching the load cell seating element to the deck by inserting a respective fixing means through the or each slot and respective aperture, wherein the load cell seating element is configured to move with the deck, in use; providing a base comprising a second seat for receipt of another end of a load cell; aligning the first seat and the second seat by moving the load cell seating element relative to the deck; and providing a load cell between the first seat and the second seat.

For the avoidance of doubt, any of the features described herein apply equally to any aspect of the disclosure. For example, the load transfer assembly, kit of parts or method may comprise any one or more features of the weighbridge relevant to the load transfer assembly, kit or parts or method and/or the method may comprise any one or more features or steps relevant to one or more features of the weighbridge, kit of parts or the load transfer assembly. Furthermore, the weighbridge may comprise one or more features of the load transfer assembly relevant to the weighbridge.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. For the avoidance of doubt, the terms “may”, “and/or”, “e.g.”, “for example” and any similar term as used herein should be interpreted as non-limiting such that any feature so-described need not be present. Indeed, any combination of optional features is expressly envisaged without departing from the scope of the disclosure, whether or not these are expressly claimed. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Embodiments of the disclosure will now be described by way of example only with reference to the accompanying drawings in which:

FIG. 1 is an upper perspective view of a weighbridge in accordance with an aspect of the disclosure;

FIG. 2 is an upper perspective view of a load transfer assembly in accordance with an aspect of the disclosure;

FIG. 3 is an exploded view of the load transfer assembly of FIG. 2;

FIG. 4 is a lower perspective view of an adjustment means of the load transfer assembly of FIG. 2;

FIG. 5 is an upper perspective view of part of a load cell alignment compensator of the load transfer assembly of FIG. 2;

FIG. 6 is a cross-sectional view through a load cell supporting element of the load transfer assembly of FIG. 2.

FIG. 7 is a bottom view of a portion of an end-box having a load cell seating element;

FIG. 8 is an exploded view of the load cell seating element of FIG. 7; and

FIG. 9 is a lower perspective view of a load cell seating element attached to a bracket of a load transfer assembly in accordance with an aspect of the disclosure.

### DETAILED DESCRIPTION

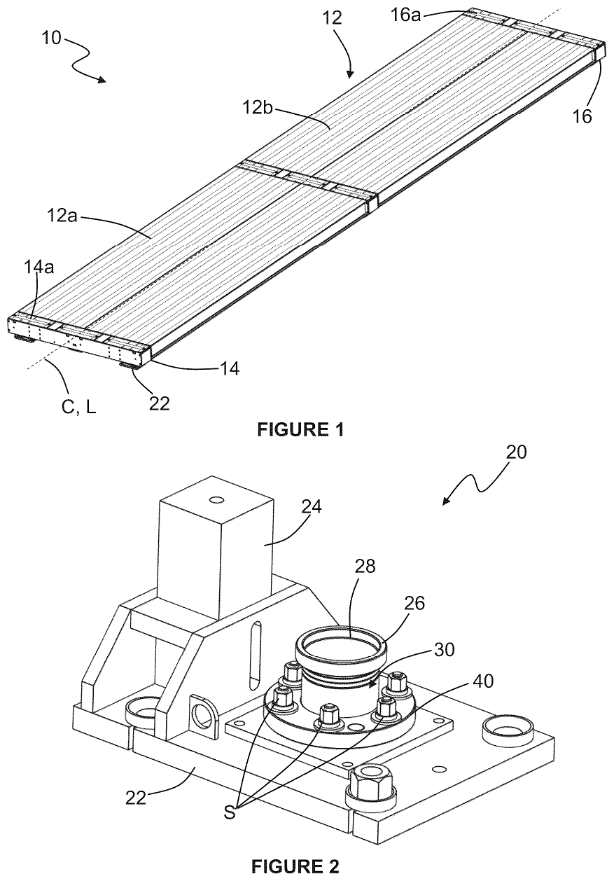

Referring now to FIG. 1, there is shown a weighbridge 10, which is a modular weighbridge in this embodiment, having a deck 12 configured to support a vehicle and provide a planar driving surface such that a vehicle weighing operation can be carried out. The deck 12 is formed of two modular deck sections 12a, 12b in this embodiment.

The deck 12 is generally rectangular when viewed in plan and extends along a longitudinal axis L between first and second ends 14, 16, which are terminal ends of the deck in this embodiment. The weighbridge 10 is also symmetrical about a central axis C which is parallel to the longitudinal axis L. A first end box 14a is provided at the first end 14, and a second end box 16a is provided at the second end 16. It will be appreciated that the first and second end boxes 14a, 16a are identical in this embodiment, but in some embodiments they may be different. Furthermore, each end box 14a, 16a, defines a widthwise extending receptacle arranged to house or receive a measuring device, e.g. a load cell.

The deck 12 includes a substructure comprising a plurality of bases or pads (hereinafter bases) 22 each forming part of a load transfer assembly 20 (discussed in greater detail below). The bases 22 are positioned at the corners of the deck 12, within the end boxes 14a, 16a, and are configured to attach the deck 12 to a static substrate e.g. the ground, a concrete foundation or a concrete pad at a weighbridge site (not shown).

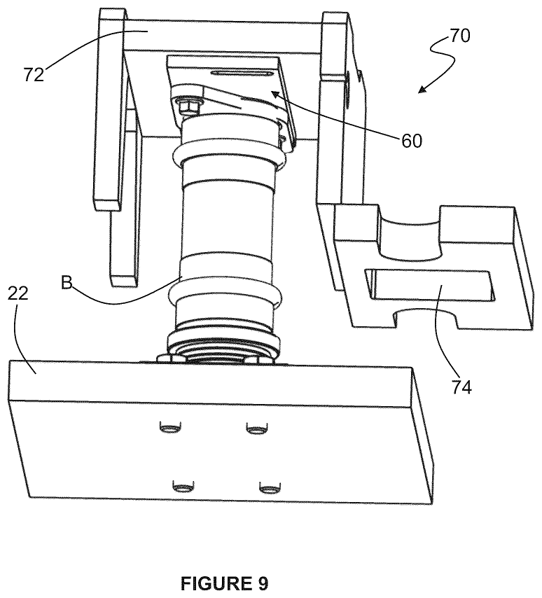

Referring now to FIG. 2, there is shown a load transfer assembly 20 in accordance with an aspect of the disclosure for use in a weighbridge 10 (FIG. 1). The load transfer assembly 20 is configured to be received below the deck of a weighbridge 10 and transfer displacement of the weighbridge 10 to a compression load cell B (FIG. 9) such that the mass of a vehicle located on the weighbridge 10 can be determined.

The load transfer assembly 10 includes a generally rectangular base 22 for attachment to a static substrate, e.g. the ground or a foundation of a weighbridge, and includes a protrusion 24 extending generally perpendicular therefrom. The protrusion 24 is rectangular when viewed in plan and is configured to engage an opening (not shown) in the weighbridge 10 to restrict lateral displacement of the deck 12 in the X and Y axes relative to the base 22, in use.

The load transfer assembly 20 includes a first seat 26 having a recess 28 on a first side for receipt of an end of the load cell B and a protrusion 29 extending from a second side. An adjustment means 30 is provided to facilitate adjustment of the first seat 26 relative to the base 22 along a Z or vertical axis (hereinafter Z axis).

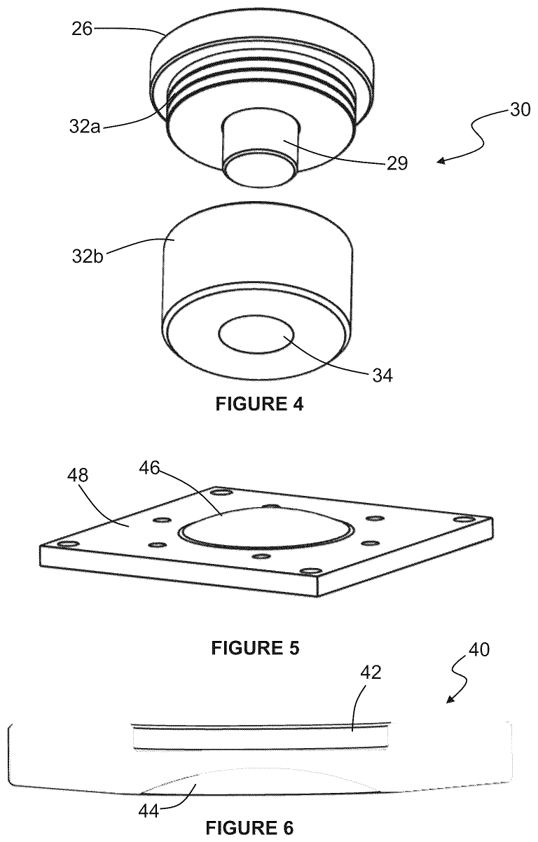

As is shown in FIGS. 2 to 4, the adjustment means 30 includes a plurality of spacing elements 32, in the form of annular discs in this embodiment, positioned between the base 22 and the first seat 26. The spacing elements 32 are removable, stacked, and have different thicknesses. In this embodiment, three spacing elements 32a each having a first thickness are stacked with a spacing element 32b having a second thickness greater than the first thickness such that the spacing element 32b is located closer than the spacing elements 32a to the base 22. As is shown in FIG. 4, in particular, the protrusion 29 is configured to engage a central aperture 34 defined by the spacing elements 32 such that lateral displacement of the first seat 26 in the X and Y axes relative to the adjustment means 30 is restricted.

The load transfer assembly 20 has a load cell supporting element 40 in engagement with a portion of the base 22. The load cell supporting element 40 is a disc and includes a spacing element seat 42 on a deck facing side thereof for receipt of the lower most spacing element 32b such that the spacing elements 30 are positioned between the load cell supporting element 40 and the first seat 26.

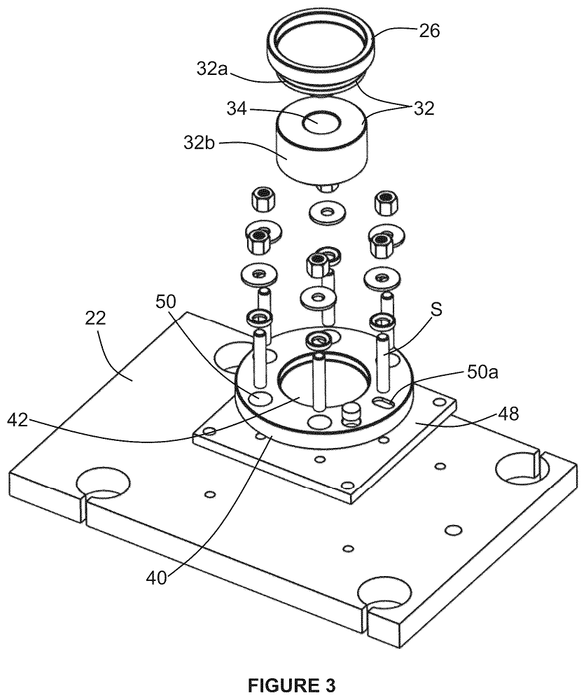

Referring now to FIGS. 3, 5 and 6, the load cell supporting element 40 forms part of a load cell alignment compensator. The load cell alignment compensator is positioned between the base 22 and the first seat 26 and includes a concave recess 44 located on a base facing side of the load cell supporting element 40. The concave recess 44 is configured to engage a convex protrusion 46 provided on a generally square plate member 48 attached to the base. In the present embodiment, the load cell supporting element 40 is movable relative to the convex protrusion 46 by virtue of engagement of the concave recess 44 with the convex protrusion 46. This facilitates adjustment of the angle of the first seat 26 relative to the base 22., in use, such that a longitudinal axis of the load cell B need not be parallel to the Z axis.

In order to ensure contact between the concave recess 44 and the convex protrusion 46, the load cell supporting element 40 is attached to the plate member 48 via six screws S received within apertures 50 equally spaced around the spacing element sear 42. One of the apertures 50a is a slot to allow the load cell supporting element 40 to pivot.

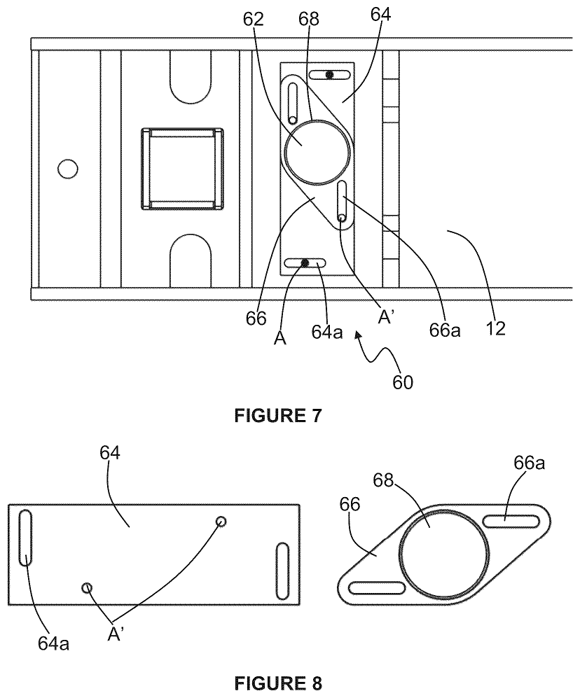

Referring now to FIGS. 7 to 9, there is shown a load cell seating element 60 of the load transfer assembly 20. The load cell seating element 60 is arranged to be attached to the deck 12 (FIG. 9) and is configured to move therewith. The load cell seating element 60 includes a second seat 62 for receipt of another end of the load cell B.

As will be explained below, the load cell seating element 60 is configured to allow for positional adjustment of the second seat 62 relative to the deck 12.

The load cell seating element 60 includes a first plate 64 mounted to the deck 12 and a second plate 66 mounted to the first plate 64. In the present embodiment, the second plate 66 has an aperture 68 and the second seat 62 is defined by the aperture 68 and the first plate 64 provided at the base of the second seat 62.

The first plate 64 has a first pair of parallel, identical mounting slots 64a each aligned with a respective aperture A in the deck 12 and the second plate 66 includes a second pair of parallel, identical mounting slots 66a each aligned with a respective aperture A′ in the first plate 64. The first pair of mounting slots 64a extends transverse or orthogonal to the second pair of mounting slots 66a. In the present embodiment, the first pair of mounting slots 64a extends laterally and the second pair of mounting slots 66a extend longitudinally.

It will be appreciated that the position of the second seat 62 relative to the deck 12 can be adjusted in dependence on the alignment between the mounting slots 64a, 66a and the apertures A, A′.

Referring now to FIG. 9, as an alternative to the arrangement shown in FIGS. 7 and 8, the load cell seating element 60 may be attached to the deck 12 via a bracket 70. The bracket 70 is an inverted U-channel section and the load cell seating element 60 is attached to the base 72 of the U-channel section 70. The bracket 70 is attached to an underside of the deck 12, within an end box 14a, 14b, and is constrained to move with the deck 12, in use.

The bracket 70 includes an aperture 74 configured to engage the protrusion 24 as shown in FIG. 1.

It will be appreciated by those skilled in the art that several variations to the aforementioned embodiments are envisaged without departing from the scope of the disclosure.

It will also be appreciated by those skilled in the art that any number of combinations of the aforementioned features and/or those shown in the appended drawings provide clear advantages over the prior art and are therefore within the scope of the disclosure described herein.

1. A weighbridge comprising:
a deck;
a load cell; and
a load transfer assembly configured to transfer displacement of the deck to the load cell, in use;
wherein the load transfer assembly comprises:
a base for attachment to a static substrate, the base comprising a first seat for receipt of an end of the load cell;
a load cell seating element attached to the deck and configured to move therewith, wherein the load cell seating element comprises:
a second seat for receipt of another end of the load cell; and
one or more mounting slots for attaching the load cell seating element to the deck, wherein the mounting slots are configured to allow for positional adjustment of the second seat relative to the deck.

2. The weighbridge according to claim 1, wherein the mounting slots comprise a pair of laterally extending slots configured to allow for lateral adjustment of the second seat relative to the deck.

3. The weighbridge according to claim 1, wherein the mounting slots comprise a pair of longitudinally extending slots configured to allow for longitudinal adjustment of the second seat relative to the deck.

4. The weighbridge according to claim 1, wherein the load cell seating element comprises a first plate mounted to the deck and a second plate mounted to the first plate.

5. The weighbridge according to claim 4, wherein the second plate comprises an aperture and the second seat is defined by the aperture and the first plate.

6. The weighbridge according to claim 4, wherein the first plate comprises a first pair of mounting slots and the second plate comprises a second pair of mounting slots, wherein the first pair of mounting slots extend orthogonal to the second pair of mounting slots.

7. The weighbridge according to claim 6, wherein the first pair of mounting slots extend laterally with respect to the deck.

8. The weighbridge according to claim 6, wherein each of the mounting slots of the first pair of mounting slots is aligned with a respective aperture in the deck and each of the mounting slots of the second pair of mounting slots is aligned with a respective aperture in the first plate.

9. The weighbridge according to claim 1, wherein the first plate is located between the deck and the second plate, and wherein the second plate is attached to the deck via the first plate.

10. The weighbridge according to claim 1, wherein the load transfer assembly comprises an adjustment means to facilitate adjustment of the first seat relative to the base.

11. The weighbridge according to claim 10, wherein the adjustment means comprises a spacing element positioned between the base and the first seat.

12. (canceled)

13. The weighbridge according to claim 11, wherein the spacing element comprises an aperture and the first seat comprises a projection, and wherein the projection engages the aperture.

14. The weighbridge according to claim 11, comprising a plurality of stacked spacing elements.

15. (canceled)

16. The weighbridge according to claim 1, wherein the load transfer assembly comprises a load cell alignment compensator positioned between the first seat and the base, wherein the load cell alignment compensator comprises a convex protrusion configured to facilitate adjustment of the angle of the first seat relative to the base, in use.

17. The weighbridge according to claim 16, wherein the load transfer assembly comprises a load cell supporting element mounted to the base, wherein the load cell supporting element comprises the first seat and a concave portion configured to engage the convex protrusion, and wherein the load cell supporting element is movable relative to the convex protrusion to facilitate adjustment of the angle of the first seat relative to the base, in use.

18. The weighbridge according to claim 16, wherein the adjustment means comprises a spacing element positioned between the base and the first seat, and comprising a base plate having a first side comprising a seat for receipt of a spacing element and second side comprising a concave portion configured to engage the convex protrusion.

19. The weighbridge according to claim 1, wherein the load transfer assembly is received within an end box of the weighbridge.

20. A load transfer assembly for a weighbridge, the assembly comprising:
a base for attachment to a static substrate, the base comprising a first seat for receipt of an end of the load cell;
a load cell seating element arranged to be attached to a deck of a weighbridge, and configured to move therewith, in use, wherein the load cell seating element comprises:
a second seat for receipt of another end of the load cell; and
one or more mounting slots for attaching the load cell seating element to a deck of a weighbridge, wherein the mounting slots are configured to allow for positional adjustment of the second seat relative to the deck, in use.

21. The load transfer assembly according to claim 17, further comprising a load cell supporting element mounted to the base, wherein the load cell supporting element comprises the first seat, and wherein the load cell supporting element comprises an adjustment means to facilitate adjustment of the first seat relative to the base.

22. The load transfer assembly according to claim 18, wherein the adjustment means comprises a removable spacing element positioned between the base and the first seat.

23. (canceled)
